(19) United States
(12) Patent Application Publication
(10) Pub. No.: US 2011/0154682 A1
(43) Pub. Date: Jun. 30, 2011

(54) Device and Method for Automatically Opening and Closing a Material Container During a Lyophilization Process

(75) Inventors: Wei Y. Kuu, Libertyville, IL (US); Steven L. Nail, West Lafayette, IN (US)

(73) Assignees: BAXTER INTERNATIONAL INC., Deerfield, IL (US); BAXTER HEALTHCARE S.A., Glattpark (Opfikon) (CH)

(21) Appl. No.: 12/981,001

(22) Filed: Dec. 29, 2010

Related U.S. Application Data
(60) Provisional application No. 61/291,150, filed on Dec. 30, 2009.

(51) Int. Cl. F26B 5/06; F26B 13/30

(52) U.S. Cl. 34/284; 34/92

(57) ABSTRACT

A device for storing a material to be lyophilized includes a support panel, a sidewall, an opening, a cover, and at least one lifter device. The sidewall and the support panel define a storage space for accommodating a material. The opening is defined by a rim of the sidewall. The cover is removably disposed adjacent to the rim of the sidewall for closing the opening. The lifter device is disposed between the support panel and the cover and includes a reservoir and at least one movable wall. The reservoir defines a sealed cavity containing a fluid. The movable wall is in operable communication with the fluid in the sealed cavity and engaging the cover to displace the cover away from the rim when the lifter device is subject to an ambient pressure that is less than the pressure of the fluid in the sealed cavity.

### CROSS-REFERENCE TO RELATED APPLICATION

The benefit under 35 U.S.C. §119(e) of U.S. Provisional Patent Application Ser. No. 61/291,150 filed Dec. 30, 2009, is hereby claimed, and the disclosure thereof is hereby incorporated by reference herein.

### FIELD OF THE DISCLOSURE

The present disclosure is generally directed to devices, systems, and methods for lyophilizing materials and, more particularly, to devices, systems, and methods for automatically aseptically sealing materials before and after a lyophilization process, while automatically unsealing for a lyophilization step.

### BACKGROUND

Lyophilization, which can also be referred to as freeze-drying, is a dehydration process typically used to preserve a perishable material or make the material more convenient for transport. Lyophilization works by freezing the material and then reducing the surrounding pressure and adding sufficient heat to allow the frozen water in the material to sublimate, i.e., transition, directly from a solid to a gas. The gas is then removed from the material to complete the dehydration.

Conventional lyophilization processes are carried out with freeze-drying machines located within laboratories or production facilities, for example, and which define internal chambers for containing the material to be lyophilized. The material to be lyophilized will often be formulated within production facilities and then introduced into the lyophilization chamber in open vessels such as vials, bottles, or other containers. As such, the gas can easily exhaust from the open vessels during the lyophilization process.

In the pharmaceutical industry materials that are lyophilized, however, require more careful handling to prevent contamination. For example, the pharmaceuticals should be contained in sterile environment while being transported through the laboratories or production facilities before and after lyopholization. The containers in which the substance which is to be lyophilized is contained may form a part of a sterile barrier between the substance and the environment, but such containers must be open to enable the gas to exhaust therefrom during lyophilization.

For medical containers such a vials, the containment in the sterile environment is maintained using different techniques. For example, prior to going into the lyophilization chamber the vials are filled in a fill room which maintains a sterile environment. Stoppers are then partially inserted into the opening or mouth of the vial. The stoppers are constructed in such a manner that even though the stoppers are partially inserted, a passageway for gas to flow into and out of the interior of the vial is maintained. The vials are then moved into the lyophilization chamber. The lyophilization process is then conducted. Prior to exit from the lyophilization chamber the shelf on which the vials sit moves upward toward the lower planar surface of the immediately adjacent overhead shelf, with that surface contacting and pushing the stoppers further into the mouth of the vial to fully seal the interior of the vial from the environment. The vials may then be removed from the lyophilization chamber into a non-sterile environment.

For other containers such as syringes, or flexible containers or bags, such a process of partially inserting stoppers into the mouth and then fully sealing the containers prior to exit from the lyophilization chamber is not practical. Syringes utilize pistons that generally require a configuration which does not lend itself to partial insertion while still maintaining a gas flow passageway. Flexible containers may not have the rigidity to withstand the force necessary to fully insert a stopper without buckling.

Therefore, to maintain sterility these containers must be maintained in a sterile environment upon exit from the lyophilization chamber, until such containers reach a sterile environment for further sealing. Providing such a sterile environment immediately adjacent the lyophilization chamber greatly increases the expense and complexity of such production facilities.

Therefore, there is a need for a device and process which allows for the interior of a container to be open during the lyophilization cycle but maintains the open containers in a sterile environment after such cycle such that they may be transported to a sterile environment remote from the lyophilization chamber while still maintaining the sterility of the interior of the containers.

### SUMMARY

One aspect of the present disclosure provides a device for storing a material to be lyophilized. The device generally includes a support panel, a sidewall, an opening, a cover, and at least one lifter device. The sidewall extends transverse to the support panel. The sidewall and the support panel define a storage space for accommodating a material. The opening is defined by a rim of the sidewall that is spaced away from the support panel. The cover is removably disposed adjacent to the rim of the sidewall for closing the opening. The at least one lifter device is disposed between the support panel and the cover and includes a reservoir and at least one movable wall. The reservoir defines a sealed cavity containing a fluid. The at least one movable wall is in operable communication with the fluid in the sealed cavity and engaging the cover to displace the cover away from the rim when the at least one lifter device is subject to an ambient pressure that is less than the pressure of the fluid in the sealed cavity.

The at least one lifter device can optionally include a cylinder and a sealing piston slidably disposed relative to the cylinder. The cylinder defines the reservoir and the cavity, and the piston defines the movable wall.

The lifter device can include a syringe such that the cylinder comprises a syringe tube and the piston comprises a syringe plunger.

The at least one lifter device can include a bellows defining the sealed cavity.

The device can further include a gasket disposed between the cover and the rim of the sidewall adjacent to the opening for sealing the opening when the cover is the closed position.

The gasket can be attached to and extend around a perimeter portion of the cover.

The gasket can define the at least one lifter device and include a tubular gasket defining the sealed cavity and a resilient sidewall portion defining the at least one movable wall.

The sidewall can include four sidewall panels arranged such that the sidewall has a generally square or rectangular cross-section.

The at least one lifter device can include four lifter devices, each lifter device being disposed within a corner defined by an adjacent pair of the sidewall panels.

The device can further include at least one biasing member coupled to the cover and biasing the cover into the closed position.

The at least one biasing member can include four springs, each spring having a first end coupled to the cover and a second end coupled to the sidewall or the support panel for biasing the cover into the closed position.

The at least one biasing member can include at least one of a compression spring, an elastic cord, and a rubber band.

Another aspect of the present disclosure includes a system for lyophilizing material. The system generally includes a freeze drying machine defining a chamber, and a device of any of the foregoing aspects, wherein the device is adapted to be disposed in the chamber.

Another aspect of the present disclosure includes a method of facilitating the lyophilization of a material. The method includes loading the material into a material container having a rim and a removable cover disposed adjacent to the rim. The method further includes loading the material container into a lyophilization chamber of a freeze drying machine while the removable cover is in a closed position engaging the rim. The method further includes lyophilizing the material and automatically lifting the cover into an opened position spaced from the rim of the container by reducing the ambient pressure in the lyophilization chamber while lyophilizing the material to allow at least one component of the material to exhaust from the container. The method further includes automatically returning the cover to the closed position engaging the rim of the container after lyophilizing the material by raising the ambient pressure in the lyophilization chamber.

Automatically lifting the cover into an opened position can optionally include generating a lifting force with a movable wall of at least one lifter device that is disposed adjacent to the cover by expanding a fluid within a sealed cavity of the at least one lifter device.

Generating a lifting force with a movable wall can include generating a lifting force with a sealing piston that is at least partly slidably disposed within a cylinder by expanding a fluid within a sealed cavity of the cylinder.

Generating a lifting force with a movable wall can include generating a lifting force with a cover that is operably connected to a bellow by expanding a fluid within a sealed cavity of the bellows.

Generating a lifting force with a movable wall can include generating a lifting force with a resilient sidewall portion of a tubular gasket by expanding a fluid within a sealed cavity of the tubular gasket.

The method can further include urging the cover into the closed position with a closing force that is smaller than the lifting force.

Urging the cover into the closed position can include urging the cover into the closed position with at least one biasing member coupled to the cover and the container.

Urging the cover into the closed position can include establishing a pressure in the lyophilization chamber that is at least equal to the pressure of the fluid in the sealed cavity of the lifter device.

Urging the cover into the closed position can include establishing a pressure in the lyophilization chamber that is greater than the pressure of the fluid in the sealed cavity of the lifter device.

The method can further include restoring the pressure in the lyophilization chamber after lyophilizing the material such that the closing force overcomes the lifting force and urges the cover into the closed position.

### BRIEF DESCRIPTION OF THE DRAWINGS

FIG. 1 is a perspective view of a system for lyophilizing material constructed in accordance with the principles of the present disclosure and including a freeze-dryer and a lyophilization chamber accommodating a container adapted to contain the material to be lyophilized;

FIG. 2 is a cross-sectional view of the container of FIG. 1 constructed in accordance with the principles of the present disclosure and including a plurality of lifter devices occupying a first position such that a cover of the container is in a closed position;

FIG. 3 is a top view of the container of FIGS. 1 and 2 with its cover lifted;

FIG. 4 is a cross-sectional view of the container of FIGS. 1-3 including the plurality of lifter devices occupying a second position such that the cover of the container is in an opened position;

FIG. 5 is a detail view of an alternative embodiment of the lifter devices of the container of FIGS. 2-4;

FIG. 6 is a cross-sectional side view of an alternative embodiment of a container constructed in accordance with the principles of the present disclosure including a lifter device occupying a first position such that the cover of the container is in a closed position;

FIG. 7 is a cross-sectional view of the container of FIG. 6 including the lifter device occupying a second position such that the cover of the container is in an opened position;

FIG. 8 is a side view of the container of FIG. 7 taken from the perspective of line VIII-VIII of FIG. 7;

FIG. 9 is a cross-sectional side view of another alternative embodiment of a container constructed in accordance with the principles of the present disclosure, including a plurality of lifter devices occupying a first position such that a cover of the container is in a closed position; and

FIG. 10 is a cross-sectional side view of a container constructed in accordance with the principles of the present disclosure and including a filter attached to the cover for enabling the flow of fluid out of the container during lyophilization.

### DETAILED DESCRIPTION

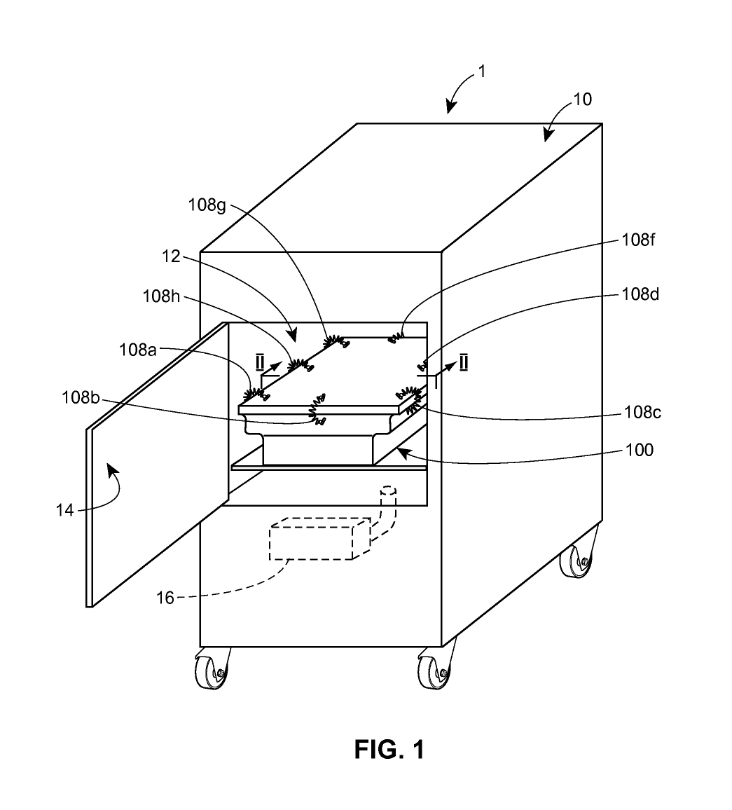

FIG. 1 depicts a system 1 for lyophilizing material and including a freeze-drying machine 10 accommodating a container 100, which is adapted to contain the material to be lyophilized. The freeze-dryer 10 defines a lyophilization chamber 12 that is selectively openable/closeable with a door 14, for example in a conventional manner. The container 100 is disposed within the lyophilization chamber 12 such that any material carried within the container 100 can be lyophilized after the door 14 is closed and the freeze-drying machine 10 is activated. To lyophilize the material in the container 100, the freeze-drying machine 10 reduces the temperature within the lyophilization chamber 12 to a temperature in the range of approximately negative fifty degrees Celsius (−50° C.) to approximately negative eighty degrees Celsius (−80° C.), for example. Then, the ambient pressure of the lyophilization chamber 12 is reduced with a vacuum pump 16, for example, to a pressure that is substantially less than atmospheric pressure, such as a pressure in the range of approximately 1.33 Pa (0.01 Torr) to approximately 133 Pa (1 Torr). With the ambient pressure reduced, a sufficient amount of heat is added to the lyophilization chamber 12 to sublimate the frozen water in the material from a solid to a gas. The gas can be removed from the material and collected on a condenser plate, for example, such that the material remains “freeze-dried.” The pressure within the lyophilization chamber 12 can then be increased or returned to the ambient pressure that is outside of the lyophilization chamber 12, and the dried material can be removed from the freeze-drying machine 10.

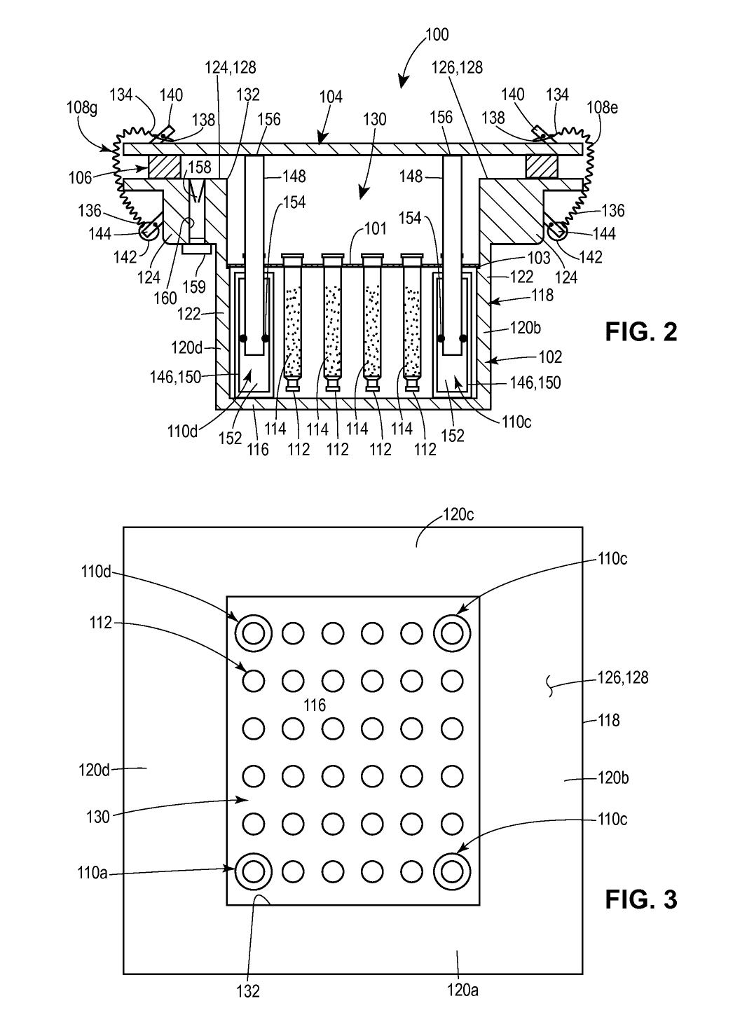

Referring now to FIGS. 2-4, one embodiment of the container 100 depicted in FIG. 1 will be described. The container 100 is generally arranged and configured to provide a sealed environment for transporting material to be lyophilized, or material that has already been lyophilized. Such materials can include pharmaceuticals or bio-materials, for example. The present disclosure is not limited to being used with such materials, however, and can be used to lyophilize generally any desired material.

The container 100 generally includes a tub 102, a cover 104, a gasket 106, first through eighth biasing members such as springs 108a-108h (see FIGS. 1 and 2), and first through fourth lifter devices 110a-110d (see FIGS. 2 and 3). Only the fifth and seventh biasing members 108e, 108g are illustrated in FIG. 2 for the sake of clarity. Moreover, as illustrated, the present embodiment of the container 100 includes a storage space 130 that is adapted to contain a plurality of vessels 112 of material 114. The vessels 112 are each depicted as including a syringe tube suspended from a support plate 101, for example, but other embodiments can include generally any type of container for holding the material 114. For example, the vessels 112 can include vials, beakers, cups, bowls, trays or any plurality of material handling devices whether suspended from a support plate or otherwise supported within the storage space 130. Moreover, in some embodiments, the container 100 does not necessarily have to be adapted to accommodate a plurality of vessels 112, but rather, can contain a single vessel 112 containing material 114. The single vessel 112 can include a pan, a bowl, a beaker, a tray, or generally any other material handling device. In still further embodiments, the tub 102 of the container 100 itself can directly contain the material 114, thereby eliminating the need for any intervening vessel 112.

The tub 102 includes a support panel 116 and a sidewall 118 extending upward from around the periphery and the support panel 116. The tub 102 of the present embodiment is generally box-shaped with a rectangular or square horizontal cross-section, and therefore, the sidewall 118 includes first through fourth sidewall panels 120a-120d. As depicted in FIG. 2, each sidewall panel 120a-120d includes a stepped outer profile constructed by a lower sidewall portion 122 and an upper sidewall portion 124. The upper sidewall portion 124 includes an upper horizontal surface 126 that defines a rim 128 of the sidewall 118. The rim 128 defines an opening 132 of the tub 102, which is in communication with the storage space 130 containing the vessels 112. The lower sidewall portion 122 includes a lip 103 extending into the storage space 130 and supporting the support plate 101 suspending the vessels 112.

The cover 104 is a generally flat structure shaped to at least correspond with the cross-sectional shape of the tub 102. More specifically, the cover 104 is shaped to at least correspond to the shape of the rim 128 of the tub 102 such that the cover 104 can close the tub 102 and seal the storage space 130 against contamination. In the present embodiment, this seal is facilitated by the gasket 106, which is attached to the outer periphery of the cover 104 and adapted to sealingly engage the rim 128 of the tub 102. In other embodiments, the optional gasket 106 can be attached to the rim 128 and adapted to sealingly engage the outer periphery of the cover 104. The gasket 106 can be constructed of generally any type of material capable of creating a fluid and/or air tight seal between the cover 104 and the rim 128 such as an elastomer, a rubber, a cork, or generally any other material. While the gasket 106 is depicted as having a generally square cross-section, gaskets with other cross-sectional shapes are intended to be within the scope of the present disclosure. That is, the gasket 106 can have a rectangular cross-section, a circular cross-section, or generally any other foreseeable shape cross-section.

The first through eighth biasing members 108a-108h are spaced about the outer periphery of the tub 102 for urging the cover 104 into the closed position depicted in FIG. 2 and maintaining the closed position. Each of the biasing members 108a-108h can include a coil spring, a rubber or other elastic element (e.g., a rubber band, an elastic cord), or generally any other type of element capable of serving the intended purpose.

As shown in FIG. 2, each of the first through eighth biasing elements 108a-108h includes a first end 134 connected to the cover 104 and a second end 136 connected to the tub 102. More specifically, the first end 134 of each biasing member 108a-108h includes a first hook 138 extending around a first pin 140 extending from the cover 104. The second end 136 of each biasing member 108a-108h includes a second hook 142 extending around a second pin 144 extending from the sidewall 118 of the tub 102. Accordingly, it should be appreciated that the cover 104 includes eight first pins 140, and the tub 102 includes eight second pins 144.

While the present embodiment includes the second ends 136 of the biasing members 108a-108h connected to the sidewall 118 of the tub 102 and, more particularly, the upper portions 124 of the sidewall panels 120a-120d, in alternative embodiments, the second ends 136 of the biasing members 108a-108h can be connected to the support panel 116 or any other portion of the tub 102, for example. Moreover, while the biasing members 108a-108h are connected to the tub 102 and cover 104 with hooks 138, 142 and pins 140, 144, any means for making such a connection is intended to be within the scope of the present disclosure. In an alternative embodiment, the cover can be hinged to the tub 102, and preferably employ fewer biasing members and lifter devices.

The first through fourth lifter devices 110a-110d of the present embodiment are positioned within corners of the storage space 130 of the tub 102 and supported on the support panel 116. As depicted in FIG. 2, each lifter device 110a-110d of the present embodiment includes a cylinder 146 and a piston 148 at least partly slidably disposed in the cylinder 146. The cylinder 146 includes a reservoir 150 defining a cavity 152 containing a fluid at a pressure that is equivalent to atmospheric pressure of approximately 101 kPa (760 Torr). The fluid in the cavity 152 can include a gas such as air, for example, a liquid, or some combination of liquid and gas. The piston 148 includes an elongated member slidably disposed within the cylinder 146 and carrying a seal 154 sealingly engaging the inside wall of the cylinder 146, thereby defining the cavity 152 as a sealed cavity. Each piston 148 further defines a movable wall 156 on an end thereof, opposite the cylinder 146.

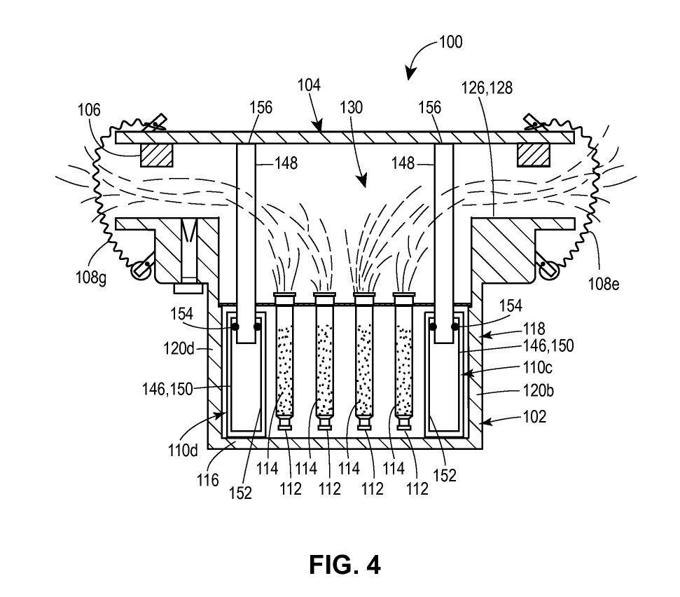

With the container 100 configured as described, the lifter devices 110 are capable of automatically moving from a first position (FIG. 2) to a second position (FIG. 4) to move the cover 104 from a closed state engaging the rim 128 (FIG. 2) to an open state spaced from the rim 128 (FIG. 4) while the material 114 disposed within the vessels 112 undergoes a lyophilization process.

For example, as discussed above, any lyophilization process conducted by the freeze-drying machine 10 depicted in FIG. 1, for example, includes reducing the pressure within the lyophilization chamber 12 to a pressure substantially less than atmospheric pressure, therefore, substantially less than the pressure in the sealed cavities 152 of the cylinders 146 of the lifter devices 110. In some embodiments, the pressure within the lyophilization chamber 12 can be reduced to a pressure in the range of approximately 1.33 Pa (0.01 Torr) to approximately 133 Pa (1 Torr) by activating the vacuum pump 16. Other ranges between atmospheric pressure and absolute vacuum are intended to be within the scope of the present disclosure.

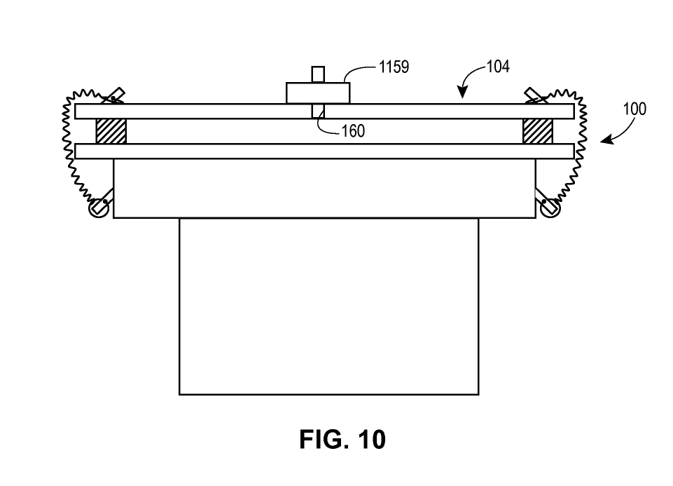

In the present embodiment of the container 100 described with reference to FIGS. 2-4, the foregoing reduction in pressure within the lyophilization chamber 12 is also communicated to the storage space 130 of the container 100. In some embodiments, the reduction in pressure in the lyophilization chamber 12 can be communicated to the storage space 130 of the container 100 via a one-way check valve 158 disposed within a through-bore 160 in the upper portion 124 of the fourth sidewall panel 120d of the sidewall 118. The check valve 158 is configured to enable the flow of fluid out of the storage space 130 of the container 100, but prevent fluid from flowing into the storage space 130. A filter 159 may also be included with the check valve to prevent the passage of any microbes through the check valve, should a leakage occur. The filter 159 preferably has a 20 micron pore size. The filter 159 may also be used without a check valve. As such, contaminants cannot penetrate the tub 102 when the cover 104 is in the closed position and it is being transported through a laboratory or production facility, for example. While the embodiment depicted in FIGS. 2-4 includes the through-bore 160, the optional filter 159, and the optional check valve 158 disposed within the upper portion 124 of the fourth sidewall panel 120d of the sidewall 118 of the container 100, alternative embodiments can be arranged differently. For example, FIG. 10 depicts an alternative embodiment of the container 100 wherein the cover 104 includes the through-bore 160 and a filter 1159. The embodiment of FIG. 10 could also optionally include a check-valve, for example, one implemented in a manner similar to check-valve 158 described above. While FIGS. 2-4 disclose the through-bore 160 disposed in the sidewall 118 of the container 100 at location adjacent to the cover 104, and FIG. 10 discloses the through-bore 160 in the cover 104 itself, the through-bore 160 does not necessarily have to be positioned near or in the cover 104. For example, the through-bore 160, as well as the optional filter 159, 1159, can be located in generally any wall of the container 100 that communicates with the storage space 130.

As the pressure within the storage space 130 is reduced below atmospheric pressure, which is also the pressure in the sealed cavities 152 of the cylinders 146 of the lifter devices 110, the fluid (e.g., a gas) in each of the sealed cavities 152 automatically expands and moves the corresponding piston 148 partly out of the cylinder 146 from the first position (FIG. 2) to the second position (FIG. 4). While the pistons 148 move from the first position to the second position, the movable walls 156 engage the cover 104, as shown, to move the cover 104 from the closed position (FIG. 2) to the opened position (FIG. 4). When the cover 104 is in the opened position, the storage space 130 of the tub 102 is in open communication with the ambient atmosphere of the lyophilization chamber 12. Accordingly, as the frozen water within the material 114 in the vessels 112 sublimates to a gas during lyophilization, the gas is free to exhaust from the vessels 12 and the storage space 130, as illustrated in FIG. 4.

After a suitable lyophilization cycle, which can be chosen by a person of ordinary skill in the art, the freeze-drying machine 10 then raises the ambient pressure within the lyophilization chamber 12. In some embodiments, the pressure in the lyophilization chamber 12 can be raised by deactivating the vacuum pump 16 and opening a vent, for example, to allow the pressure to stabilize relative to the pressure outside the freeze-drying machine 10. In some embodiments, the pressure in the lyophilization chamber 12 is raised to be substantially equal to atmospheric pressure, i.e., 101 kPa. As the ambient pressure within the lyophilization chamber 12 increases, the ambient pressure within the storage space 130 of the tub 102 increases because the cover 104 is in the opened position and the fluid within the sealed cavities 152 of the cylinders 146 of the lifter devices 110 compresses and draws the pistons 148 back toward the first position (FIG. 2). As the pistons 146 return to the first position, the biasing members 108a-108g automatically urge the cover 104 back to the closed position (FIG. 2). With the cover 104 in the closed position, the gasket 106 provides a fluid tight seal against the rim 128 of the tub 102 and prevents communication between the storage space 130 and the surrounding environment. The container 100 can then be safely removed from the lyophilization chamber 12 and transported about the laboratory or production facility without concern for contaminating the lyophilized material 114.

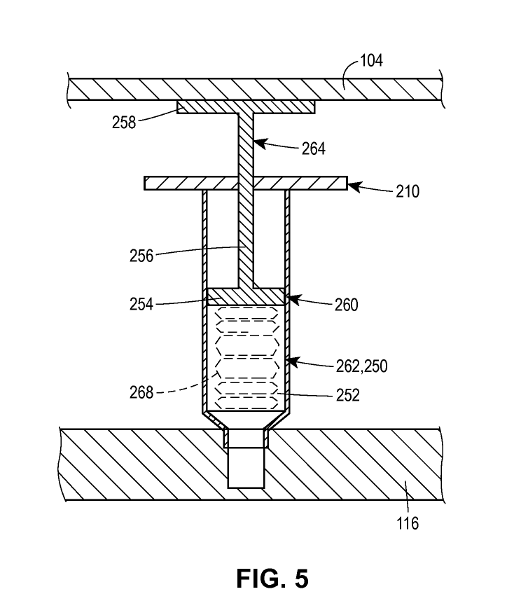

While the lifter devices 110 of the container 100 disclosed in FIGS. 2-4 include simple cylinders 146 and pistons 148, alternative embodiments of the lifter devices 110 can be constructed differently. For example, FIG. 5 depicts an alternative lifter device 210 that could be used in a manner generally identical to that described above with respect to the lifter devices 110 depicted in FIGS. 2-4.

The lifter device 210 depicted in FIG. 5 generally includes a conventional syringe 260 including a syringe tube 262 and a plunger 264 partly slidably disposed within the syringe tube 262. The syringe tube 262 includes a reservoir 250 defining a cavity 252 containing a fluid, for example, at a pressure that is equivalent to atmospheric pressure (101 kPa). The plunger 264 includes an elongated member slidably disposed within the syringe tube 262 and having a sealing disk 254, a stem 256, and a movable wall 258. The sealing disk 254 engages the inside wall of the syringe tube 262 to provide a fluid tight seal, thereby defining the cavity 252 as a sealed cavity.

In some alternative embodiments, the lifter device 210 of FIG. 5 can further include a bellows 268, which is shown with dashed lines in FIG. 5, disposed within the cavity 252 of the syringe tube 262. The bellows 268 can include a sack formed in an accordion-like configuration and containing the fluid, for example, that defines the sealed cavity 252 of the lifter device 210. As such, the bellows 268 is expandable and contractable in response to changes in the ambient pressure for moving the plunger 264 in and out of the syringe tube 262 for moving the cover 104 between the opened and closed positions. Therefore, when the bellows 268 is included within the lifter device 210, the sealing disk 254 does not need to provide a fluid-tight seal against the syringe tube 262.

As shown, the lifter device 210 of FIG. 5 can be supported on the support panel 116 of the tub 102 depicted in FIG. 2, for example. Moreover, the movable wall 258 of the plunger 264 can be disposed in engagement with the cover 104 for moving the cover 104 from the closed position to the opened position in a manner identical to that described above. In alternative embodiments, the syringe 260 of FIG. 5 can be suspended from the support plate 101 depicted in FIG. 2 in a manner identical to the vessels 112 of FIG. 2.

While the lifter devices 110, 210 have thus far been described as being disposed within the storage space 130 of the tube 102 of the container 100, in alternative embodiments, these lifter devices 110, 210 could be reduced in size, for example, and disposed between the rim 128 of the tub 102 and the cover 104 at a location adjacent to the gasket 106 depicted in FIG. 2. The lifter devices 110, 210 of such an alternative embodiment could be located inside or outside of the gasket 106. If the lifter devices 110, 210 were located outside of the gasket 106, and, therefore, in direct communication with the atmosphere of the lyophilization chamber 16, the tub 102 may not require the through-bore 160 and check valve 158 because the reduction in pressure in the lyophilization chamber 16 would directly act on the lifter devices 110, 210.

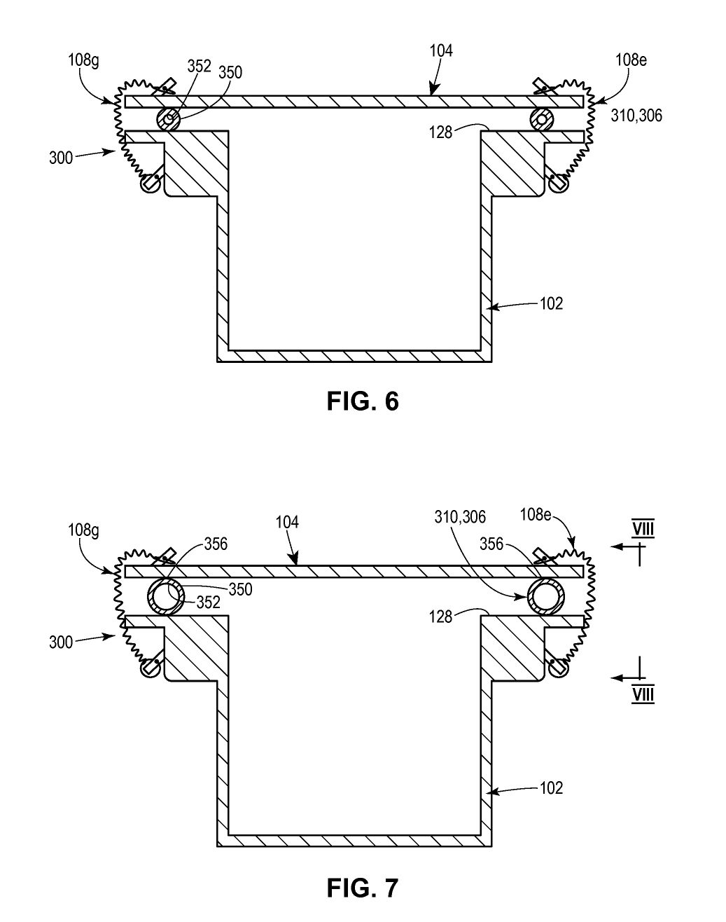

Further, while the foregoing embodiments of the container 100 of the present disclosure have thus far been disclosed as including lifter devices 110, 210 with moving parts, FIGS. 6-8 depict an alternative embodiment of a container 300 constructed in accordance with the principles of the present disclosure including a gasket 306 that serves as a lifter device 310. Many aspects of the container 300 can be similar to the aspects of the container 100 described above, and therefore, like features will be identified with like reference numerals.

Similar to that described above, the container 300 includes a tub 102, a cover 104, and first through eighth biasing members 108a-108h, only two of which are depicted in FIG. 6. The tub 102 of the embodiment of the container 300 is generally identical to the tub 102 described above with reference to the container 100 depicted in FIGS. 2-4, with the exception that the container 300 does not include a through-bore 160 or a check valve 158. The container 300 of FIGS. 6-8 can optionally not include these features because the lifter device 310, i.e., the gasket 306, is in direct communication with the ambient atmosphere of the lyophilization chamber 12, as will be described.

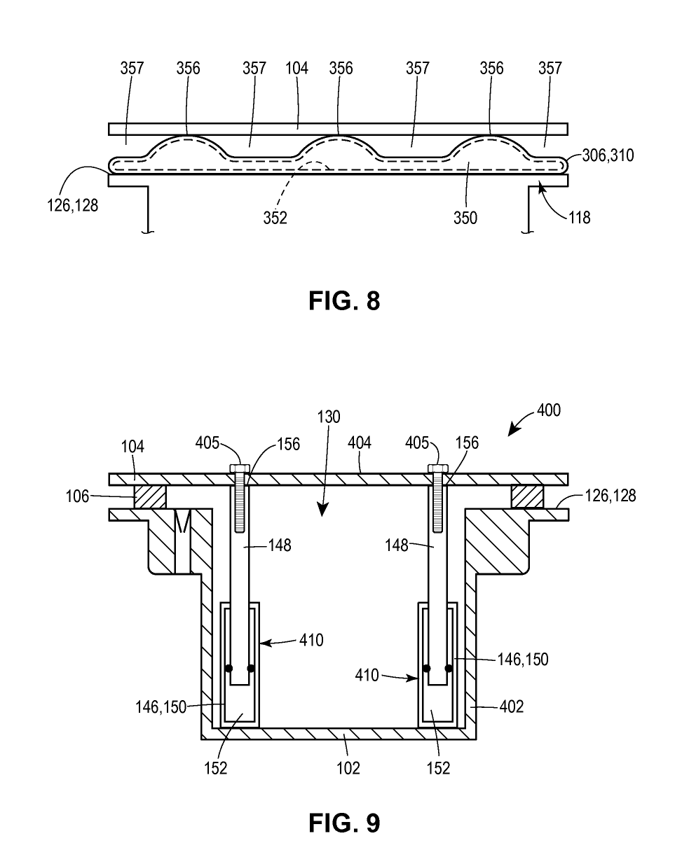

The gasket 306 of the embodiment of the container 300 of FIGS. 6-8 is disposed between the cover 104 and the rim 128 of the tub 102 and connected to the rim 128. In alternative embodiments, the gasket 306 could be connected to the cover 104. The gasket 306 is of a generally tubular construction such that the gasket 306 itself includes one reservoir 350 defining one sealed cavity 352 containing a fluid generally at atmospheric pressure. Moreover, the gasket 306 includes a plurality of movable walls 356, as depicted in FIG. 8, for example, that serve to move the cover 104 from a closed position (FIG. 6) to an opened position (FIGS. 7 and 8). In alternative embodiments, the gasket 306 can include a plurality of tubular portions adjacent the movable walls 356 and separated by solid portions. As such, some alternative embodiments of the gasket 306 can have a plurality of sealed cavities 352 defined by the plurality of tubular portions. The movable walls 356 are spaced apart along the length of the gasket 306. Moreover, the movable walls 356 can include thinned-out resilient sidewall portions of the gasket 306 such that the movable walls 356 expand when the pressure inside of the sealed cavity 352 exceeds the ambient pressure surrounding the gasket 306, as shown in FIG. 8.

Accordingly, when undergoing a lyophilization process such as that described above, the reduction in pressure within the lyophilization chamber 12 of the freeze-drying machine 10 causes the fluid within the sealed cavity 352 of the gasket 306 to expand, thereby moving the movable walls 356 away from the remainder of the gasket 306, which, in turn, moves the cover 104 to the opened position. Because the movable walls 356 are spaced along the gasket 306, gaps 357 are formed between the gasket 306 and the cover 104 to allow gas to exhaust out of the tub 102 during lyophilization. Moreover, when the ambient pressure within the lyophilization chamber 12 is increased, the movable walls 356 return to their normal position depicted in FIG. 6 and the biasing members 108a-108h urge the cover 104 back to the closed position. With the movable walls 356 in the normal position, the gasket 306 provides a fluid tight seal between the tub 102 and cover 104.

While the gasket 306 of the embodiment depicted in FIGS. 6-8 has been described as being fixed to the rim 128 of the tub 102 such that the movable walls 356 move upward against the cover 104 to open the cover 104, in alternative embodiments, the gasket 306 could be fixed to the cover 104. For example, the movable walls 356 could be adhered to the cover 104, or the gasket 306, as depicted in FIG. 8 could be flipped such that the movable walls 356 move downward against the rim 128 of the tub 102 to open the cover 104.

While each of the foregoing embodiments of the containers 100, 300 includes a plurality of biasing members 108 connected between the cover 104 and the tub 102 for returning and maintaining the cover 104 in the closed position, FIG. 9 depicts one alternative embodiment of a container 400 that does not include the biasing members 108. The container 400 can be generally similar to the container 100 described above with reference to FIGS. 2-4, and therefore, only the distinctions will be described. Specifically, as mentioned, the container 400 does not include the biasing members 108. The movable walls 156 of the lifter devices 110, however, are fixed to the cover 104 to move the cover 104 from the opened position to the closed position, and to maintain the cover 104 in the closed position when the container 400 is being transported, for example.

In the disclosed embodiment, the cover 104 is fixed to the movable wall 156 of each of the lifter devices 110 via a threaded fastener 405. In other embodiments, the cover 104 can be fixed to the movable wall 156 of each lifter device 110 with a snap, Velcro®, an adhesive, or generally any other device. With the container 400 so configured, the lifter devices 110 move the cover 104 to the opened position in a manner identical to that which is described above regarding the container 100 depicted in FIGS. 2-4 when the ambient pressure in the lyophilization chamber 12 is reduced below the pressure of the fluid in the sealed cavities 152 of the lifter devices 110. Upon the ambient pressure being increased, the fluid in the sealed cavities 152 compresses and draws the movable walls 156 downward. Because the movable walls 156 are connected to the cover 104, this compression of fluid in the lifter devices 110 also pulls the cover 104 back into sealing engagement with the tub 102.

In some embodiments, the pressure of the fluid in the sealed cavities 152 of the lifter devices 110 can be maintained at a pressure that is actually less than atmospheric pressure such that when the container 400 is removed from the lyophilization chamber 12 and transported, for example, the movable walls 156 of the lifter devices 110 apply a continuous force pulling the cover 104 downward against the gasket 106 to maintain a fluid tight seal. In some embodiments, the pressure of the fluid in the sealed cavity 152 can be maintained at a pressure that is less than atmospheric pressure, but greater than the lowest pressure reached within the lyophilization chamber 12 during the lyophilization process, which can be as low as 133 kPa (1 Torr), for example. As such, the pressure in the sealed cavities 152 of the lifter devices 110 of this particular embodiment can be in the range of approximately 1330 Pa (10 Torr) to approximately 90 kPa (700 Torr), and in one embodiment approximately 40 kPa (300 Torr), for example.

While the concept of connecting the movable walls 156 of the lifter devices 110 to the cover 104 to eliminate the biasing members 108 has thus far only been described with reference to the lifter devices 110 depicted in FIGS. 2-4 and 9, this concept can also be applied to the lifter devices 210, 310 described above with reference to FIG. 5 and FIGS. 6-8. That is, in FIG. 5, the movable wall 258 of the plunger 264 of the syringe 260 can be fixed to the cover 104 to eliminate the need for the biasing members 108. Moreover, the movable walls 356 of the gasket 306 of FIGS. 6-8 could similarly be fixed to the cover 104 and/or the rim 128 of the tub 102 depending on the orientation of the gasket 306.

Moreover, while the concept of maintaining the pressure of the fluid in the sealed cavities 152 of the lifter devices 110 has only been described with reference to the lifter devices 110 depicted in FIGS. 2-4 and 9, this concept can also be applied to the lifter devices 210, 310 described above with reference to FIG. 5 and FIGS. 6-8. That is, in FIG. 5, the pressure of the fluid in the sealed cavity 252 or within the bellows 268 could be maintained below atmospheric pressure to apply a constant downward force to the cover 104. Moreover, the pressure of the fluid in the sealed cavity 352 of the gasket 306 could similarly be maintained at a pressure below atmospheric pressure.

In view of the foregoing, it should be appreciated that the various embodiments described herein provide examples of various devices, systems, and methods constructed in accordance with the principles of the present disclosure. These embodiments are not meant to be exclusive embodiments, but rather, any of the embodiments can be modified to include any one or more features of any of the other embodiments. As such, it should be appreciated that the examples provided herein are not exhaustive and the various features are interchangeable with each other, as well as with features not specifically disclosed but understood by a person having ordinary skill in the art.

What is claimed:

1. A device for storing a material to be lyophilized, the device comprising:
a support panel;
a sidewall extending transverse to the support panel, the sidewall and the support panel defining a storage space for accommodating a material;
an opening defined by a rim of the sidewall that is spaced away from the support panel;
a cover removably disposed adjacent to the rim of the sidewall for closing the opening; and
at least one lifter device disposed between the support panel and the cover and comprising a reservoir and at least one movable wall, the reservoir defining a sealed cavity containing a fluid, the at least one movable wall in operable communication with the fluid in the sealed cavity and engaging the cover to displace the cover away from the rim when the at least one lifter device is subject to an ambient pressure that is less than the pressure of the fluid in the sealed cavity.

2. The device of claim 1, wherein the at least one lifter device comprises a cylinder and a piston slidably disposed relative to the cylinder, the cylinder defining the reservoir and the cavity, the piston defining the movable wall.

3. The device of claim 2, wherein the lifter device comprises a syringe such that the cylinder comprises a syringe tube and the piston comprises a syringe plunger.

4. The device of claim 1, wherein the at least one lifter device comprises a bellows defining the sealed cavity.

5. The device of claim 1, further comprising a gasket disposed between the cover and the rim of the sidewall adjacent to the opening for sealing the opening when the cover is the closed position.

6. The device of claim 5, wherein the gasket is attached to and extends around a perimeter portion of the cover.

7. The device of claim 5, wherein the gasket defines the at least one lifter device and comprises a tubular gasket defining the sealed cavity and a resilient sidewall portion defining the at least one movable wall.

8. The device of claim 1, wherein the sidewall comprises four sidewall panels arranged such that the sidewall has a generally square or rectangular cross-section.

9. The device of claim 8, wherein the at least one lifter device comprises four lifter devices, each lifter device disposed within a corner defined by an adjacent pair of the sidewall panels.

10. The device of claim 1, further comprising at least one member coupled to the cover and biasing the cover into the closed position.

11. The device of claim 10, wherein the at least one member comprises four springs, each spring having a first end coupled to the cover and a second end coupled to the sidewall or the support panel for biasing the cover into the closed position.

12. The device of claim 11, wherein the at least one member comprises at least one of a compression spring, an elastic cord, and a rubber band.

13. A method of facilitating the lyophilization of a material, the method comprising:
loading the material into a material container having a rim and a removable cover disposed adjacent to the rim;
loading the material container into a lyophilization chamber of a freeze drying machine while the removable cover is in a closed position engaging the rim;
lyophilizing the material;
automatically lifting the cover into an opened position spaced from the rim of the container by reducing the ambient pressure in the lyophilization chamber while lyophilizing the material to allow at least one component of the material to exhaust from the container; and
automatically returning the cover to the closed position engaging the rim of the container after lyophilizing the material by raising the ambient pressure in the lyophilization chamber.

14. The method of claim 13, wherein automatically lifting the cover into an opened position further comprises generating a lifting force with a movable wall of at least one lifter device that is disposed adjacent to the cover by expanding a fluid within a sealed cavity of the at least one lifter device.

15. The method of claim 14, wherein generating a lifting force with a movable wall comprises generating a lifting force with a piston that is at least partly slidably disposed within a cylinder by expanding a fluid within a sealed cavity of the cylinder.

16. The method of claim 14, wherein generating a lifting force with a movable wall comprises generating a lifting force with a cover that is operably connected to a bellows by expanding a fluid within a sealed cavity of the bellows.

17. The method of claim 14, wherein generating a lifting force with a movable wall comprises generating a lifting force with a resilient sidewall portion of a tubular gasket by expanding a fluid within a sealed cavity of the tubular gasket.

18. The method of claim 14, further comprising urging the cover into the closed position with a closing force that is smaller than the lifting force.

19. The method of claim 18, wherein urging the cover into the closed position comprises urging the cover into the closed position with at least one biasing member coupled to the cover and the container.

20. The method of claim 18, wherein urging the cover into the closed position comprises establishing a pressure in the lyophilization chamber that is at least equal to the pressure of the fluid in the sealed cavity of the lifter device.

21. The method of claim 18, wherein urging the cover into the closed position comprises establishing a pressure in the lyophilization chamber that is greater than the pressure of the fluid in the sealed cavity of the lifter device.

22. The method of claim 18, further comprising restoring the pressure in the lyophilization chamber after lyophilizing the material such that the closing force overcomes the lifting force and urges the cover into the closed position.
